(19) United States
(12) Patent Application Publication
(10) Pub. No.: US 2023/0087183 A1
(43) Pub. Date: Mar. 23, 2023

(54) PROCESS FOR MAKING A MIXED OXIDE, AND MIXED OXIDES

(71) Applicant: BASF SE, Ludwigshafen Am Rhein (DE)

(72) Inventors: Xiaohan WU, Ludwigshafen (DE); Doron AURBACH, Ramat Gan (IL); Hadar SCLAR, Ramat Gan (IL); Boris MARKOVSKY, Ramat Gan (IL); Sandipan MAITI, Ramat Gan (IL)

(21) Appl. No.: 17/906,278

(22) PCT Filed: Mar. 22, 2021
(86) PCT No.: PCT/EP2021/057256

§ 371 Date: Sep. 14, 2022

(30) Foreign Application Priority Data
Mar. 26, 2020 (EP) 20165812.7

(51) Int. Cl. H01M 4/485; H01M 4/04; H01M 4/505; H01M 4/525; H01M 10/0525

(52) U.S. Cl. CPC H01M 4/485; H01M 4/0471; H01M 4/505; H01M 4/525; H01M 10/0525; H01M 2004/028

(57) ABSTRACT

Process for making a cathode active material for a lithium ion battery, said process comprising the following steps: (a) treating a mixed oxide according to general formula Li₁₊ₓTM₁₋ₓO₂ with at least one aromatic di-, tri- or tetracarboxylic acid or with a combination of at least two of the foregoing, wherein TM is a combination of Mn and Ni and, optionally, at least one more metal selected from Ba, Al, Co, Ti, Zr, W, Fe, Cr, K, Mo, Nb, Ta, Mg and V, and x is in the range of from zero to 0.2, (b) subjecting said precursor to heat treatment a temperature in the range of from 500 to 800° C.

The present invention is directed towards a process for making a cathode active material for a lithium ion battery, said process comprising the following steps:
(a) treating a mixed oxide according to general formula Li₁₊ₓTM₁₋ₓO₂ with at least one aromatic di-, tri- or tetracarboxylic acid or with a combination of at least two of the foregoing, wherein TM is a combination of Mn and Ni and, optionally, at least one more metal selected from Ba, Al, Co, Ti, Zr, W, Fe, Cr, K, Mo, Nb, Ta, Mg and V, and x is in the range of from zero to 0.2,
(b) subjecting said precursor to heat treatment a temperature in the range of from 500 to 800° C.

Lithiated transition metal oxides are currently being used as electrode active materials for lithium-ion batteries. Extensive research and developmental work have been performed in the past years to improve properties like charge density, specific energy, but also other properties like the reduced cycle life and capacity loss that may adversely affect the lifetime or applicability of a lithium-ion battery. Additional effort has been made to improve manufacturing methods.

In a typical process for making cathode materials for lithium-ion batteries, first a so-called pre-cursor is being formed by co-precipitating the transition metals as carbonates, oxides or preferably as hydroxides that may or may not be basic. The precursor is then mixed with a source of lithium such as, but not limited to LiOH, Li₂O or Li₂CO₃ and calcined (fired) at high temperatures. Lithium salt(s) can be employed as hydrate(s) or in dehydrated form. The calcination—or firing—generally also referred to as thermal treatment or heat treatment of the precursor—is usually carried out at temperatures in the range of from 600 to 1,000° C. During the thermal treatment a solid-state reaction takes place, and the electrode active material is formed. The thermal treatment is performed in the heating zone of an oven or kiln.

An ongoing issue remains the problem of capacity fade. Various theories exist about the reason for the capacity fade, and—among others—the surface properties the cathode active materials have been modified, for example by coating with an inorganic oxide or with polymers. All of the suggested solutions leave room for improvement.

It was therefore an objective of the present invention to provide cathode active materials with low capacity fading and thus a high cycling stability. It was further an objective to provide a process for making cathode active materials with both a low capacity fading and thus a high cycling stability. It was further an objective to provide applications of cathode active materials with low capacity fading and thus a high cycling stability.

Accordingly, the process defined at the outset has been found, hereinafter also referred to as inventive process or process according to the present invention.

The inventive process comprises the following steps (a) and (b), hereinafter also referred to as step (a) and step (b) or briefly as (a) or (b), respectively:
(a) treating a mixed oxide according to general formula Li₁₊ₓTM₁₋ₓO₂ with at least one aromatic di-, tri- or tetracarboxylic acid or with a combination of at least two of the foregoing, wherein TM is a combination of Mn and Ni and, optionally, at least one more metal selected from Ba, Al, Co, Ti, Zr, W, Fe, Cr, K, Mo, Nb, Ta, Mg and V, and x is in the range of from zero to 0.2,
(b) subjecting said precursor to heat treatment a temperature in the range of from 500 to 800° C.

Steps (a) and (b) will be described in more detail below.

Step (a) starts off from a mixed oxide according to general formula Li₁₊ₓTM₁₋ₓO₂, wherein TM is a combination of Mn and Ni and, optionally, at least one more metal selected from Ba, Al, Co, Ti, Zr, W, Fe, Cr, K, Mo, Nb, Ta, Mg and V, and x is in the range of from zero to 0.2. Preferably, at least one of Mg, Al, Co and Zr is present in TM.

Said TM may contain traces of further metal ions, for example traces of ubiquitous metals such as sodium, calcium or zinc, as impurities but such traces will not be taken into account in the description of the present invention. Traces in this context will mean amounts of 0.05 mol-% or less, referring to the total metal content of TM.

If present, M¹ may be dispersed homogeneously or unevenly in particles of mixed oxide according to general formula Li₁₊ₓTM₁₋ₓO₂. Preferably, such M¹ is distributed unevenly in particles of such mixed oxide, even more preferably as a gradient, with the concentration of M¹ in the outer shell being higher than in the center of the particles.

In one embodiment of the present invention, mixed oxide according to general formula Li₁₊ₓTM₁₋ₓO₂ has an average particle diameter (D50) in the range of from 3 to 20 μm, preferably from 5 to 16 μm. The average particle diameter may be determined, e. g., by light scattering or LASER diffraction or electroacoustic spectroscopy. The particles are usually composed of agglomerates from primary particles, and the above particle diameter refers to the secondary particle diameter.

In one embodiment of the present invention, TM is a combination of transition metals according to general formula (I a)

(NiₐCo_{b}Mn_{c})_{1-d}M¹_{d} (I a)

with

a being in the range of from 0.3 to 0.95, preferably 0.6 to 0.9, and more preferably 0.6 to 0.85,

b being in the range of from 0.05 to 0.4, preferably 0.05 to 0.2,

c being in the range of from zero to 0.6, preferably zero to 0.2, and

d being in the range of from zero to 0.1, preferably 0.001 to 0.005,

M¹ being selected from Ba, Al, Ti, Zr, W, Fe, Cr, Mo, Nb, Ta, Mg, and V, and from combinations of at least two of the foregoing, preferably M¹ is selected from Mg, Al, Co and Zr.

In such embodiments, zero≤x≤0.1.

In one embodiment of the present invention, mixed oxides with TM according to formula (I a) have a surface (BET) in the range of from 0.1 to 1.0 m²/g. The BET surface may be determined by nitrogen adsorption after outgassing of the sample at 200° C. for 30 minutes and, beyond this, according to DIN-ISO 9277:2003-05.

In one embodiment of the present invention, mixed oxides with TM according to formula (I a) have a pressed density in the range of from 3.5 to 3.7 g/cm³, determined at a pressure of 250 MPa.

In one embodiment of the present invention, TM is a combination of transition metals according to general formula (I b)

(NiₐCo_{b}Mn_{c})_{1-d}M¹_{d} (I b)

a is in the range of from 0.30 to 0.38, preferably 0.30 to 0.35,

b being in the range of from zero to 0.05, preferably b is zero,

c being in the range of from 0.60 to 0.70, preferably 0.65 to 0.70, and

d being in the range of from zero to 0.05,

M¹ is selected from Al, Ti, Zr, W, Mo, Mg and combinations of at least two of the foregoing, and 0.1≤x≤0.2.

Some mixed oxides with TM according to formula (I b) have a pressed density in the range of from 2.5 to 2.7 g/cm³.

Preferred mixed oxides with TM according to formula (I b) have a pressed density in the range of from 2.75 to 3.30 g/cm³, preferably from 2.80 to 3.20 g/cm³. The pressed density is determined at a pressure of 250 MPa.

In one embodiment of the present invention, mixed oxides with TM according to formula (I b) have a surface (BET) in the range of from 0.7 to 4.0 m²/g. The BET surface may be determined by nitrogen adsorption after outgassing of the sample at 200° C. for 30 minutes and, beyond this, according to DIN-ISO 9277:2003-05, preferred are 1.7 to 3.8 m²/g.

Mixed oxides with TM according to formula (I b) are preferred.

In step (a), such mixed oxide according to general formula Li₁₊ₓTM₁₋ₓO₂ is treated with at least one aromatic di-, tri- or tetracarboxylic acid, hereinafter also referred to in general as “aromatic carboxylic acid”. Aromatic di-, tri- or tetracarboxylic acids used in step (a) may be based on benzene or on naphthalene, for example naphthalene 2,6-dicarboxylic acid or naphthalene 2,7-dicarboxylic acid, di-, tri- or tetracarboxylic acids benzene being preferred. Aromatic di-, tri- or tetracarboxylic acids used in step (a) may bear one or two substituents other than COOH groups, for example methyl groups, but preferably they do not bear substituents other than COOH groups. Preferred examples of aromatic dicarboxylic acids are phthalic acid, isophthalic acid and terephthalic acid and mixtures of at least two of the foregoing. Preferred examples of tricarboxylic acid are benzene-1,2,3-tricarboxylic acid and benzene-1,2,4-tricarboxylic acid, trimesic acid (see below) being preferred

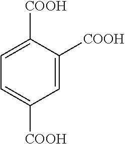 [SMILES: O=C(O)c1ccc(C(=O)O)c(C(=O)O)c1]

Preferred example of tetracarboxylic acids is benzene 1,2,4,5-tetracarboxylic acid.

Most preferred example of dicarboxylic acids is terephthalic acid, and most preferred example of tricarboxylic acids is trimesic acid.

In one embodiment of the present invention, an amount of 0.1 to 5% by weight of aromatic carboxylic acid is used in step (a), preferably 0.5 to 3% by weight, referring to mixed oxide according to general formula Li₁₊ₓTM₁₋ₓO₂.

Preferably, aromatic carboxylic acid is applied in solution, for example in an organic solvent, for example alcohols such as methanol, ethanol, and iso-propanol, and hydrocarbons such as toluene, xylene, n-heptane. Alcohols such as methanol, ethanol, and iso-propanol are preferred.

In one embodiment of the present invention, the concentration of aromatic carboxylic acid in such organic solvent is in the range of from 0.1 to 10 g/l, preferably 0.2 to 5 g/l.

Said treating of mixed oxide according to general formula Li₁₊ₓTM₁₋ₓO₂ and aromatic carboxylic acid(s) according to step (a) is—preferably in the presence of an organic solvent—carried out by combining mixed oxide according to general formula Li₁₊ₓTM₁₋ₓO₂ and aromatic carboxylic acid in a vessel, followed by a mixing operation such as stirring or shaking. Suitable vessels are tank reactors, plough share mixers, free-fall mixers, tumble mixers. For laboratory scale experiments, roller mills or mortars with pestles may be applied as well.

In one embodiment of the present invention, 1 to 250 g of mixed oxide according to general formula Li₁₊ₓTM₁₋ₓO₂ are combined with one liter of solution of aromatic carboxylic acid in such organic solvent, preferably 10 to 150 g. If the amount of organic solvent is higher, the process may become uneconomic due to the high capacity of vessels needed.

In one embodiment of the present invention, step (a) is carried out at elevated temperature, for example at 50 to 100° C., preferably 70 to 95° C., even more preferably to the boiling point of the organic solvent used.

In the course or at the end of step (a), the organic solvent—if present—will be evaporated. It is preferred to distill off the organic solvent in the course of step (a).

In one embodiment of the present invention, step (a) is carried out at ambient pressure, preferably at the pressure that allows the organic solvent to evaporate completely.

In one embodiment of the present invention, the duration of step (a) is in the range of from one to two hours.

To perform step (b) of the inventive process, the mixture obtained according to step (c) is heated at a temperature in the range of from 500 to 800° C., preferably 550 to 650° C.

Step (b) may be performed in an oxygen-containing atmosphere. Oxygen-containing atmosphere includes an atmosphere of air, of pure oxygen, of mixtures from oxygen with air, and of air diluted with an inert gas such as nitrogen. In step (b), an atmosphere of oxygen or oxygen diluted with air or nitrogen and a minimum content of oxygen of 21 vol.-% is preferred.

It is preferred, though, to perform step (b) in a non-oxidizing atmosphere, for example under nitrogen or a rare gas, especially under argon. Preferred is argon.

In order to remove gaseous reaction products from step (b), it is preferred to perform step (b) with an exchange of the atmosphere, for example under a flow of gas.

Step (b) of the inventive process may be performed in a furnace, for example in a rotary tube furnace, in a muffle furnace, in a pendulum furnace, in a roller hearth furnace or in a push-through furnace. Combinations of two or more of the aforementioned furnaces are possible as well.

Step (b) of the inventive process can be performed over a period of 30 minutes to 24 hours, preferably 1 to 12 hours. Step (b) can be effected at a constant temperature level, or a temperature profile can be run.

In one embodiment of the present invention, between steps (a) and (b) at least one step is performed to remove organic solvent from step (a)t, for example a pre-heating step (b*). Step (b*) comprises heating the mixture obtained in step (a) at a temperature in the range of from 100 to 400° C. for a period of 2 to 24 hours.

During the temperature changes, a heating rate of 1 K/min up to 10 K/min can be obtained, preferred is 2 to 5 K/min.

After step (b), it is preferred to cool down the material obtained to ambient temperature. A cathode active material is obtained. Cathode active materials made according to the inventive process display a low capacity fading and thus a high cycling stability.

Without wishing to be bound by any theory, we assume structural changes of cathode active materials themselves and parasitic reactions at the interface between cathode active material and electrolyte interface are responsible for capacity fading. We further assume that by performing the inventive process, in the course of step (a) a protective surface layer is formed on the primary particles via an acid-based reaction, and then the acid is decomposed in step (b) under formation of a lithium-nickel oxide species and Li₂CO₃.

A further aspect of the present invention is a cathode active material according to general formula Li₁₊ₓ₁TM₁₋ₓ₁O₂ with at least one aromatic di-, tri- or tetracarboxylic acid or with a combination of at least two of the foregoing, wherein TM is a combination of Mn and Ni and, optionally, at least one more metal selected from Ba, Al, Co, Ti, Zr, W, Fe, Cr, K, Mo, Nb, Ta, Mg and V, and x1 is in the range of from −0-05 to 0.1.5, wherein the primary particles of said mixed oxide are covered with mixture containing a lithium nickel oxide with a cubic crystal structure and having the formula Liₓ₂Ni₂₋ₓ₂O₂ with zero≤x2≤0.5 and with Li₂CO₃. Said cathode active material is hereinafter also referred to as “inventive cathode active material”. Optionally, said layer also comprises a spinel containing lithium and nickel, for example LiNi₂O₄.

Preferably, zero<x2≤0.4.

A specific preferred material of formula Liₓ₂Ni₂₋ₓ₂O₂ is Li_{0.4}Ni_{1.6}O₂.

An example of spinel in said layer is Li₁₊₃M²₂₋ₓ₃M²₂₋ₓ₃O₄₋ₓ₄ with x3 and x4 being independently in the range of from zero to 0.4, and M² being Ni or a combination of Ni and Mn.

It is observed that the amount of compound Liₓ₂Ni₂₋ₓ₂O₂ exceeds the amounts of lithium carbonate and of spinel. In one embodiment of the present invention, in said layer, the ratio is in the range of from 70:25:05 to 65:27:08.

The term “covered” in the above context does not only refer to a complete and homogeneous layer but also to layers that may have a varying thickness in different parts of the same primary particle.

In one embodiment of the present invention, the average thickness of the aforementioned layer is in the range of from 2 to 5 nm. The existence of said layer and its thickness may be shown and deduced from a combination of X-ray diffraction (“XRD”), X-ray photoelectron spectroscopy (“XPS”) and Scanning Electron Spectroscopy (“SEM”). By said tools, said layer has a homogeneous appearance.

As with the starting material in step (a) of the inventive process, TM in inventive cathode active material may contain traces of further metal ions, for example traces of ubiquitous metals such as sodium, calcium or zinc, as impurities but such traces will not be taken into account in the description of the present invention. Traces in this context will mean amounts of 0.05 mol-% or less, referring to the total metal content of TM.

In inventive cathode active material, any M¹—if applicable—may be dispersed homogeneously or unevenly in particles of mixed oxide according to general formula Li₁₊ₓ₁TM₁₋ₓ₁O₂. Preferably, such M¹ is distributed unevenly in particles of such mixed oxide, even more preferably as a gradient, with the concentration of M¹ in the outer part being higher than in the center of the particles.

In one embodiment of the present invention, inventive cathode active material has an average particle diameter D50 in the range of from 3 to 20 μm, preferably from 5 to 16 μm. The average particle diameter may be determined, e. g., by light scattering or LASER diffraction or electroacoustic spectroscopy. The particles are composed of agglomerates from primary particles, and the above particle diameter refers to the secondary particle diameter.

In one embodiment of the present invention, TM is a combination of transition metals according to general formula (I a)

(NiₐCo_{b}Mn_{c})_{1-d}M¹_{d} (I a)

with

a being in the range of from 0.3 to 0.95, preferably 0.6 to 0.9, and even more preferably 0.6 to 0.85,

b being in the range of from 0.05 to 0.4, preferably 0.05 to 0.2,

c being in the range of from zero to 0.6, preferably zero to 0.2, and

d being in the range of from zero to 0.1, preferably 0.001 to 0.005,

M¹ is selected from Ba, Al, Ti, Zr, W, Fe, Cr, Mo, Nb, Ta, Mg, and V, and from combinations of at least two of the foregoing, preferably M¹ is selected from Mg, Al, Co and Zr.

In such embodiments, −0.05≤x≤+0.05.

In one embodiment of the present invention, inventive cathode active materials with TM according to formula (I a) have a surface (BET) in the range of from 0.1 to 1.0 m²/g. The BET surface may be determined by nitrogen adsorption after outgassing of the sample at 200° C. for 30 minutes and, beyond this, according to DIN-ISO 9277:2003-05.

In one embodiment of the present invention, mixed oxides with TM according to formula (I a) have a pressed density in the range of from 3.5 to 3.7 g/cm³, determined at a pressure of 250 MPa.

In one embodiment of the present invention, TM is a combination of transition metals according to general formula (I b)

(NiₐCo_{b}Mn_{c})_{1-d}M¹_{d} (I b)

a is in the range of from 0.30 to 0.38, preferably 0.30 to 0.35,

b being in the range of from zero to 0.05, preferably b is zero,

c being in the range of from 0.60 to 0.70, preferably 0.65 to 0.70, and

d being in the range of from zero to 0.05,

M¹ is selected from Al, Ti, Zr, W, Mo, Mg and combinations of at least two of the foregoing, and 0.05≤x≤0.15.

Some mixed oxides with TM according to formula (I b) have a pressed density in the range of from 2.5 to 2.7 g/cm³.

Preferred inventive cathode active materials with TM according to formula (I b) have a pressed density in the range of from 2.75 to 3.1 g/cm³, preferably from 2.80 to 3.10 g/cm³. The pressed density is determined at a pressure of 250 MPa.

In one embodiment of the present invention, inventive cathode active materials with TM according to formula (I b) have a surface (BET) in the range of from 0.7 to 4.0 m²/g. The BET surface may be determined by nitrogen adsorption after outgassing of the sample at 200° C. for 30 minutes and, beyond this, according to DIN-ISO 9277:2003-05, preferred are 1.7 to 3.8 m²/g.

Inventive cathode active materials with TM according to formula (I b) are preferred.

Inventive cathode active materials display a low capacity fading and thus a high cycling stability.

A further aspect of the present invention refers to cathodes, hereinafter also referred to as inventive cathodes. Inventive cathodes comprise

(A) at least one inventive cathode active material,

(B) carbon in electrically conductive form,

(C) at least one binder.

In a preferred embodiment of the present invention, inventive cathodes contain

(A) 80 to 99% by weight inventive cathode active material,

(B) 0.5 to 19.5% by weight of carbon,

(C) 0.5 to 9.5% by weight of binder material,

percentages referring to the sum of (A), (B) and (C).

Cathodes according to the present invention contain carbon in electrically conductive modification, in brief also referred to as carbon (B). Carbon (B) can be selected from soot, active carbon, carbon nanotubes, graphene, and graphite. Carbon (B) can be added as such during preparation of electrode materials according to the invention.

Electrodes according to the present invention can comprise further components. They can comprise a current collector (D), such as, but not limited to, an aluminum foil. They further comprise a binder material (C), hereinafter also referred to as binder (C). Current collector (D) is not further described here.

Suitable binders (C) are preferably selected from organic (co)polymers. Suitable (co)polymers, i.e. homopolymers or copolymers, can be selected, for example, from (co)polymers obtainable by anionic, catalytic or free-radical (co)polymerization, especially from polyethylene, polyacrylonitrile, polybutadiene, polystyrene, and copolymers of at least two comonomers selected from ethylene, propylene, styrene, (meth)acrylonitrile and 1,3-butadiene. Polypropylene is also suitable. Polyisoprene and polyacrylates are additionally suitable. Particular preference is given to polyacrylonitrile.

In the context of the present invention, polyacrylonitrile is understood to mean not only polyacrylonitrile homopolymers but also copolymers of acrylonitrile with 1,3-butadiene or styrene. Preference is given to polyacrylonitrile homopolymers.

In the context of the present invention, polyethylene is not only understood to mean homopolyethylene, but also copolymers of ethylene which comprise at least 50 mol % of copolymerized ethylene and up to 50 mol % of at least one further comonomer, for example α-olefins such as propylene, butylene (1-butene), 1-hexene, 1-octene, 1-decene, 1-dodecene, 1-pentene, and also isobutene, vinylaromatics, for example styrene, and also (meth)acrylic acid, vinyl acetate, vinyl propionate, C₁-C₁₀-alkyl esters of (meth)acrylic acid, especially methyl acrylate, methyl methacrylate, ethyl acrylate, ethyl methacrylate, n-butyl acrylate, 2-ethylhexyl acrylate, n-butyl methacrylate, 2-ethylhexyl methacrylate, and also maleic acid, maleic anhydride and itaconic anhydride. Polyethylene may be HDPE or LDPE.

In the context of the present invention, polypropylene is not only understood to mean homopolypropylene, but also copolymers of propylene which comprise at least 50 mol % of copolymerized propylene and up to 50 mol % of at least one further comonomer, for example ethylene and α-olefins such as butylene, 1-hexene, 1-octene, 1-decene, 1-dodecene and 1-pentene. Polypropylene is preferably isotactic or essentially isotactic polypropylene.

In the context of the present invention, polystyrene is not only understood to mean homopolymers of styrene, but also copolymers with acrylonitrile, 1,3-butadiene, (meth)acrylic acid, C₁-C₁₀-alkyl esters of (meth)acrylic acid, divinylbenzene, especially 1,3-divinylbenzene, 1,2-diphenylethylene and α-methylstyrene.

Another preferred binder (C) is polybutadiene.

Other suitable binders (C) are selected from polyethylene oxide (PEO), cellulose, carboxymethylcellulose, polyimides and polyvinyl alcohol.

In one embodiment of the present invention, binder (C) is selected from those (co)polymers which have an average molecular weight M_{w} in the range from 50,000 to 1,000,000 g/mol, preferably to 500,000 g/mol.

Binder (C) may be cross-linked or non-cross-linked (co)polymers.

In a particularly preferred embodiment of the present invention, binder (C) is selected from halogenated (co)polymers, especially from fluorinated (co)polymers. Halogenated or fluorinated (co)polymers are understood to mean those (co)polymers which comprise at least one (co)polymerized (co)monomer which has at least one halogen atom or at least one fluorine atom per molecule, more preferably at least two halogen atoms or at least two fluorine atoms per molecule. Examples are polyvinyl chloride, polyvinylidene chloride, polytetrafluoroethylene, polyvinylidene fluoride (PVdF), tetrafluoroethylene-hexafluoropropylene copolymers, vinylidene fluoride-hexafluoropropylene copolymers (PVdF-HFP), vinylidene fluoride-tetrafluoroethylene copolymers, perfluoroalkyl vinyl ether copolymers, ethylene-tetrafluoroethylene copolymers, vinylidene fluoride-chlorotrifluoroethylene copolymers and ethylene-chlorofluoroethylene copolymers.

Suitable binders (C) are especially polyvinyl alcohol and halogenated (co)polymers, for example polyvinyl chloride or polyvinylidene chloride, especially fluorinated (co)polymers such as polyvinyl fluoride and especially polyvinylidene fluoride and polytetrafluoroethylene.

A further aspect of the present invention is an electrochemical cell, containing

(1) a cathode comprising inventive cathode active material (A), carbon (B), and binder (C),

(2) an anode, and

(3) at least one electrolyte.

Embodiments of cathode (1) have been described above in detail.

Anode (2) may contain at least one anode active material, such as carbon (graphite), TiO₂, lithium titanium oxide, silicon or tin. Anode (2) may additionally contain a current collector, for example a metal foil such as a copper foil.

Electrolyte (3) may comprise at least one non-aqueous solvent, at least one electrolyte salt and, optionally, additives.

Non-aqueous solvents for electrolyte (3) can be liquid or solid at room temperature and is preferably selected from among polymers, cyclic or acyclic ethers, cyclic and acyclic acetals and cyclic or acyclic organic carbonates.

Examples of suitable polymers are, in particular, polyalkylene glycols, preferably poly-C₁-C₄-alkylene glycols and in particular polyethylene glycols. Polyethylene glycols can here comprise up to 20 mol % of one or more C₁-C₄-alkylene glycols. Polyalkylene glycols are preferably polyalkylene glycols having two methyl or ethyl end caps.

The molecular weight M_{w} of suitable polyalkylene glycols and in particular suitable polyethylene glycols can be at least 400 g/mol.

The molecular weight M_{w} of suitable polyalkylene glycols and in particular suitable polyethylene glycols can be up to 5,000,000 g/mol, preferably up to 2,000,000 g/mol.

Examples of suitable acyclic ethers are, for example, diisopropyl ether, di-n-butyl ether, 1,2-dimethoxyethane, 1,2-diethoxyethane, with preference being given to 1,2-dimethoxyethane.

Examples of suitable cyclic ethers are tetrahydrofuran and 1,4-dioxane.

Examples of suitable acyclic acetals are, for example, dimethoxymethane, diethoxymethane, 1,1-dimethoxyethane and 1,1-diethoxyethane.

Examples of suitable cyclic acetals are 1,3-dioxane and, in particular, 1,3-dioxolane.

Examples of suitable acyclic organic carbonates are dimethyl carbonate, ethyl methyl carbonate and diethyl carbonate.

Examples of suitable cyclic organic carbonates are compounds of the general formulae (II) and (III)

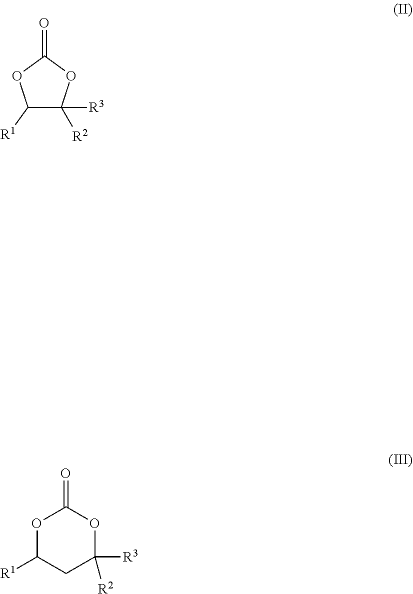

where R¹, R² and R³ can be identical or different and are selected from among hydrogen and C₁-C₄-alkyl, for example methyl, ethyl, n-propyl, isopropyl, n-butyl, isobutyl, sec-butyl and tert-butyl, with R² and R³ preferably not both being tert-butyl.

In particularly preferred embodiments, R¹ is methyl and R² and R³ are each hydrogen, or R¹, R² and R³ are each hydrogen.

Another preferred cyclic organic carbonate is vinylene carbonate, formula (IV).

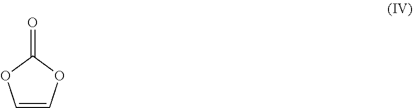

The solvent or solvents is/are preferably used in the water-free state, i.e. with a water content in the range from 1 ppm to 0.1% by weight, which can be determined, for example, by Karl-Fischer titration.

Electrolyte (3) further comprises at least one electrolyte salt. Suitable electrolyte salts are, in particular, lithium salts. Examples of suitable lithium salts are LiPF₆, LiBF₄, LiClO₄, LiAsF₆, LiCF₃SO₃, LiC(CₙF₂ₙ₊₁SO₂)₃, lithium imides such as LiN(CₙF₂ₙ₊₁SO₂)₂, where n is an integer in the range from 1 to 20, LiN(SO₂F)₂, Li₂SiF₆, LiSbF₆, LiAlCl₄ and salts of the general formula (CₙF₂ₙ₊₁SO₂)ₜYLi, where m is defined as follows:

t=1, when Y is selected from among oxygen and sulfur,

t=2, when Y is selected from among nitrogen and phosphorus, and

t=3, when Y is selected from among carbon and silicon.

Preferred electrolyte salts are selected from among LiC(CF₃SO₂)₃, LiN(CF₃SO₂)₂, LiPF₆, LiBF₄, LiClO₄, with particular preference being given to LiPF₆ and LiN(CF₃SO₂)₂.

In a preferred embodiment of the present invention, electrolyte (3) contains at least one flame retardant. Useful flame retardants may be selected from trialkyl phosphates, said alkyl being different or identical, triaryl phosphates, alkyl dialkyl phosphonates, and halogenated trialkyl phosphates. Preferred are tri-C₁-C₄-alkyl phosphates, said C₁-C₄-alkyls being different or identical, tribenzyl phosphate, triphenyl phosphate, C₁-C₄-alkyl di-C₁-C₄-alkyl phosphonates, and fluorinated tri-C₁-C₄-alkyl phosphates,

In a preferred embodiment, electrolyte (3) comprises at least one flame retardant selected from trimethyl phosphate, CH₃—P(O)(OCH₃)₂, triphenylphosphate, and tris-(2,2,2-trifluoroethyl)-phosphate.

Electrolyte (3) may contain 1 to 10% by weight of flame retardant, based on the total amount of electrolyte.

In an embodiment of the present invention, batteries according to the invention comprise one or more separators (4) by means of which the electrodes are mechanically separated. Suitable separators (4) are polymer films, in particular porous polymer films, which are unreactive toward metallic lithium. Particularly suitable materials for separators (4) are polyolefins, in particular film-forming porous polyethylene and film-forming porous polypropylene.

Separators (4) composed of polyolefin, in particular polyethylene or polypropylene, can have a porosity in the range from 35 to 50%. Suitable pore diameters are, for example, in the range from 30 to 500 nm.

In another embodiment of the present invention, separators (4) can be selected from among PET nonwovens filled with inorganic particles. Such separators can have a porosity in the range from 40 to 55%. Suitable pore diameters are, for example, in the range from 80 to 750 nm.

Batteries according to the invention can further comprise a housing which can have any shape, for example cuboidal or the shape of a cylindrical disk. In one variant, a metal foil configured as a pouch is used as housing.

Batteries according to the invention provide a very good discharge and cycling behavior, in particular at high temperatures (45° C. or higher, for example up to 60° C.) in particular with respect to the capacity loss.

Batteries according to the invention can comprise two or more electrochemical cells that combined with one another, for example can be connected in series or connected in parallel. Connection in series is preferred. In batteries according to the present invention, at least one of the electrochemical cells contains at least one electrode according to the invention. Preferably, in electrochemical cells according to the present invention, the majority of the electrochemical cells contain an electrode according to the present invention. Even more preferably, in batteries according to the present invention all the electrochemical cells contain electrodes according to the present invention.

The present invention further provides for the use of batteries according to the invention in appliances, in particular in mobile appliances. Examples of mobile appliances are vehicles, for example automobiles, bicycles, aircraft or water vehicles such as boats or ships. Other examples of mobile appliances are those which move manually, for example computers, especially laptops, telephones or electric hand tools, for example in the building sector, especially drills, battery-powered screwdrivers or battery-powered staplers.

The present invention is further illustrated by working examples.

General remark: rpm: revolution per minute

Percentages are % by weight unless expressly noted otherwise

The pressed density was determined at 250 MPa

The structural characterizations were carried out via the X-ray diffraction technique (Bruker D8 Advanced X-ray diffractometer, CuKα radiation). The intensities were recorded in the range of 2θ=10°-80°, with steps of ≈0.0194 deg./min. A standard least-square refinement procedure was taken to calculate the unit cell parameters. Morphological micrographs were analyzed by Scanning Electron Microscopy (SEM). Transmission Electron Microscopy (TEM) studies were carried out with a LaB₆-200 kV Jeol-2100 instrument operated at 200 kV. These studies were performed in TEM mode using conventional selected area diffraction (SAED) and Convergent Beam Electron Diffraction (CBED) technique. X-ray Photoelectron Spectroscopy (XPS) measurements were carried out using UHV (2.5×10⁻¹⁰ Torr base pressure) using 5600 Multi-Technique System (PHI, USA). The DSC analyses were carried out in the range between room temperature and 350° C. (DSC 3+STARe System, METTLER TOLEDO) using closed reusable high pressure gold-plated stainless steel crucibles (30 μl in volume). Chemical analysis of the transition metals dissolution from the cathode after 400 cycles was performed by the Inductive Coupled Plasma technique (SPECTRO ARCOS ICP-OES Multi-view FHX22). The lithium anodes after 400 cycles were dissolved in 10 ml of ice-cold double-distilled (DD) water for the measurement.

I. Synthesis of a Base Material, B-CAM 1

I.1 Synthesis of a Precursor, TM-OH.1

A stirred tank reactor was filled with deionized water and tempered to 45° C. Then, the pH value was adjusted to 11.3 by adding an aqueous sodium hydroxide solution.

The co-precipitation reaction was started by simultaneously feeding an aqueous transition metal sulfate solution and aqueous sodium hydroxide solution at a flow rate ratio of 1.9, and a total flow rate resulting in an average residence time of 12 hours. The transition metal solution contained Ni and Mn at a molar ratio of 1:2 and a total transition metal concentration of 1.65 mol/kg. The aqueous sodium hydroxide solution was a 50 wt. % sodium hydroxide solution. The pH value was kept at 11.3 by the separate feed of the aqueous sodium hydroxide solution. Beginning with the start-up of all feeds, mother liquor was removed continuously. After 29 hours all feed flows were stopped. The mixed transition metal (TM) oxyhydroxide precursor was obtained by filtration of the resulting suspension, washing with distilled water, drying at 120° C. in air and sieving. A precursor TM-OH.1 was obtained, average particle diameter (D50) 6 μm.

I.2 Calcination

The precursor TM-OH.1 was mixed with Li₂CO₃ in a Li/TM molar ratio of 1.15. The resultant mixture was heated to 970° C. and kept for 5 hours in a forced flow of a mixture of 20% oxygen and 80% nitrogen (by volume). After cooling to ambient temperature, the resultant powder was deagglomerated and sieved through a 32 μm mesh to obtain a base material B-CAM.1. The surface area (BET) was 1.42 m²/g, pressed density: 2.92 g/cm³.

II. Combination with Aromatic di- or Tricarboxylic Acid and Thermal Treatment

II.1 Treatment with Trimesic Acid (ac.1), Step (a.1),

A 250 ml glass beaker was charged with 5 g of B-CAM.1. 100 ml of a 2% by weight solution of trimesic acid (ac.1) in ethanol were added, followed by heating to 80° C. under stirring at 300 rpm until the ethanol had completely evaporated, which took about 90 minutes. A dry powder was obtained.

II.2 Thermal Treatment, Step (b.1)

The powder from step (a.1) was then subjected to heat treatment at 600° C. a tube furnace (Nabertherm, Germany) for 1 hour under a constant forced flow of argon. After deagglomeration, inventive CAM.1 was obtained as a free-flowing powder, average particle diameter (D50) 6 μm.

Inventive CAM.1 was analyzed by XRD, XPS and SEM. A layer of Li_{0.4}Ni_{1.6}O₂, Li₂CO₃ and spinel Liₓ₃(Ni_{0.33}Mn_{0.67})₁₋ₓ₃(Ni_{0.33}Mn_{0.67})₂O₄ could be detected on the primary particles. Thickness of the layer: 2 to 5 nm, appearing homogeneous. The quantities were estimated to be 65 to 70 mol-% Li_{0.4}Ni_{1.6}O₂, 25 to 28 mol-% Li₂CO₃ and 5 to 8 mol-% spinel.

II.3 Thermal Treatment, Step (b.2)

The powder from step (a.1) was subjected to heat treatment at 600° C. a tube furnace (Nabertherm, Germany) for 30 minutes under a constant forced flow of argon. After deagglomeration, inventive CAM.2 was obtained as a free-flowing powder, average particle diameter (D50) 6 μm.

Inventive CAM.2 was analyzed by XRD, XPS and SEM. A layer of Li_{0.4}Ni_{1.6}O₂, Li₂CO₃ and spinel Liₓ₃(Ni_{0.33}Mn_{0.67})₁₋ₓ₃(Ni_{0.33}Mn_{0.67})₂O₄ could be detected on the primary particles. Thickness of the layer: 2 to 5 nm, appearing homogeneous. The quantities were similar to CAM.1.

II.4 Treatment with Terephthalic Acid (ac.2), Step (a.2),

A 250 ml glass beaker was charged with 5 g of B-CAM.1. 100 ml of a 1% by weight solution of terephthalic acid (ac.2) in ethanol were added, followed by heating to 80° C. under stirring at 300 rpm until the ethanol had completely evaporated, which took about 90 minutes. A dry powder was obtained.

II.5 Thermal Treatment, Step (b.3)

The powder from step (a.2) was then subjected to heat treatment at 600° C. a tube furnace (Nabertherm, Germany) for 1 hour under a constant forced flow of argon. After deagglomeration, inventive CAM.3 was obtained as a free-flowing powder, average particle diameter (D50) 6 μm.

Inventive CAM.3 was analyzed by XRD, XPS and SEM. A layer of Li_{0.4} Ni_{1.6}O₂, Li₂CO₃ and spinel Liₓ₃(Ni_{0.33}Mn_{0.67})₁₋ₓ₃(Ni_{0.33}Mn_{0.67})₂O₄ could be detected on the primary particles. Thickness of the layer: 2 to 5 nm, appearing homogeneous. The quantities were estimated to be 65 to 70 mol-% Li_{0.4}Ni_{1.6}O₂, 25 to 28 mol-% Li₂CO₃ and 5 to 8 mol-% spinel.

III. Testing

Positive electrode: PVDF binder (Solef® 5130) was dissolved in NMP (Merck) to produce a 10 wt. % solution. For electrode preparation, binder solution (3.5 wt. %), carbon black (Super C65, 4 wt.-%) were slurried in NMP. After mixing using a planetary centrifugal mixer (ARE-250, Thinky Corp.; Japan), either any of inventive CAM.1 to or CAM.2 or a comparative cathode active material, for example B-CAM.1 (92.5 wt. %) was added and the suspension was mixed again to obtain a lump-free slurry. The solid content of the slurry was adjusted to 62.3%. The slurry was coated onto 15 μm thick Al foil using an Erichsen auto coater. The loading was 6 to 7 mg/cm². Prior to further use, all electrodes were calendared. The thickness of cathode material was 38 μm, corresponding to 9 mg/cm². All electrodes were dried at 105° C. for 12 hours before battery assembly.

A polypropylene separator commercially available from Cellgard was used.

III.2: Electrolyte Manufacture

A base electrolyte composition was prepared containing 1M LiPF₆, 1:4 (w/w) fluoroethylene carbonate:diethyl carbonate.

III.3 Coin-Type Half Cell Manufacture

Coin-type half cells (20 mm in diameter and 3.2 mm in thickness) comprising a cathode prepared as described under II.1 and lithium metal as working and counter electrode, respectively, were assembled and sealed in an Ar-filled glove box. In addition, the cathode and anode and a separator were superposed in order of cathode//separator//Li foil to produce a half coin cell. Thereafter, 0.15 mL of the EL base 1 which is described above (III.2) were introduced into the coin cell.

The results are summarized in Table 1.

TABLE 1
Electrochemical testing of inventive cathode active materials and of
a comparative sample

| | (1 C discharge) cycle | | | | | | | | | |
|---|---|---|---|---|---|---|---|---|---|---|
| | | | | | | | | | | Q₁₀/ |
| | | | | | | | | | | Q₄₀₀ |
| | 10^{th} | 50^{th} | 100^{th} | 150^{th} | 200^{th} | 250^{th} | 300^{th} | 350^{th} | 400^{th} | [%] |
| B- | 220 | 190 | 156 | 159 | 138 | 110 | 84 | 75 | 63 | 28.6 |
| CAM.1 | | | | | | | | | | |
| CAM.1 | 180 | 179 | 177 | 170 | 163 | 156 | 150 | 144 | 138 | 77 |
| CAM.2 | 158 | 161 | 161 | 159 | 155 | 148 | 143 | 134 | 124 | 78.5 |
| CAM.3 | 162 | 160 | 158 | 154 | 149 | 144 | 137 | 126 | 112 | 69 |

All results in mA · h/g
All values were average values from 3 coin cells.

1-15. (canceled)

16. A process for making a cathode active material for a lithium ion battery, the process comprising:
(a) treating a mixed oxide of a general formula Li₁₊ₓTM₁₋ₓO₂ with an average particle diameter (D50) ranging from 3 μm to 20 μm with at least one aromatic di-, tri- or tetracarboxylic acid or with a combination of at least two of the foregoing, wherein TM is a combination of Mn and Ni and, optionally, at least one more metal selected from Ba, Al, Co, Ti, Zr, W, Fe, Cr, K, Mo, Nb, Ta, Mg and V, and x ranges from zero to 0.2, and
(b) subjecting the mixture obtained according to step (a) to heat treatment at a temperature ranging from 500° C. to 800° C.

17. The process according to claim 16, wherein TM is a combination of transition metals according to general formula (I b)
(NiₐCo_{b}Mn_{c})_{1-d}M¹_{d} (I b)
a ranges from 0.30 to 0.38,
b ranges from zero to 0.05,
c ranges from 0.60 to 0.70, and
d ranges from zero to 0.05,
M¹ is selected from Al, Ti, Zr, W, Mo, Mg and combinations of at least two of the foregoing, and
0.1≤x≤0.2.

18. The process according to claim 16, wherein the di-carboxylic acid is selected from terephthalic acid, phthalic acid, isophthalic acid, and mixtures of at least two of the foregoing.

19. The process according to claim 16, wherein the tricarboxylic acid is trimesic acid.

20. The process according to claim 16, wherein step (a) is performed with an alcoholic solution.

21. The process according to claim 20, wherein the alcoholic solution is least one aromatic di-, tri- or tetracarboxylic acid.

22. The process according to claim 16, wherein step (b) is performed under a forced flow of gas.

23. The process according to claim 16, wherein steps (b) is performed in a roller hearth kiln, a pusher kiln, or a rotary hearth kiln.

24. The process according to claim 16, wherein steps (b) is performed in a non-oxidizing atmosphere.

25. A cathode active material according to a general formula Li₁₊ₓ₁TM₁₋ₓ₁O₂ with an average particle diameter (D50) ranging from 3 μm to 20 μm,
wherein TM is a combination of Mn and Ni and, optionally, at least one more metal selected from Ba, Al, Co, Ti, Zr, W, Fe, Cr, K, Mo, Nb, Ta, Mg and V, and ranges from −0-05 to 0.1.5,
wherein the primary particles of the mixed oxide are covered with a mixture containing lithium nickel oxide with a cubic crystal structure and having the formula Liₓ₂Ni₂₋ₓ₂O₂ with zero≤x2≤0.5 and Li₂CO₃.

26. The cathode active material according to claim 25, wherein TM is a combination of transition metals according to general formula (I b)
(NiₐCo_{b}Mn_{c})_{1-d}M¹_{d} (I b)
a ranges from 0.30 to 0.38,
b ranges from zero to 0.05,
c ranges from 0.60 to 0.70, and
d ranges from zero to 0.05,
M¹ is selected from Al, Ti, Zr, W, Mo, Mg and combinations of at least two of the foregoing,
a+b+c=1, and
0.05≤x1≤0.15.

27. The cathode active material according to claim 25, wherein the mixed oxide has an average particle diameter (D50) ranging from 3 μm to 20 μm.

28. A cathode comprising
(A) at least one cathode active material according to claim 25,
(B) carbon in electrically conductive form,
(C) at least one binder.

29. An electrochemical cell comprising a cathode according to claim 28.
